(19) United States
(12) Patent Application Publication
(10) Pub. No.: US 2024/0137404 A1
(43) Pub. Date: Apr. 25, 2024

(54) ONLINE MULTI-WORKFLOW SCHEDULING METHOD BASED ON REINFORCEMENT LEARNING

(71) Applicant: Hangzhou Dianzi University

(72) Inventors: Yuyu Yin, Hangzhou City (CN); Binbin Huang, Hangzhou City (CN); Zixin Huang, Hangzhou City (CN)

(21) Appl. No.: 18/355,420

(22) Filed: Jul. 20, 2023

(30) Foreign Application Priority Data
Jul. 20, 2022 (CN) 202210857988.8

(51) Int. Cl. H04L 67/10; G06F 9/48; G06F 9/50

(52) U.S. Cl. CPC H04L 67/10; G06F 9/4881; G06F 9/5038

(57) ABSTRACT

System model is established to characterize mobile devices, edge servers, tasks and nodes. Node unloading rule is established, and the mobile device can be selected to unload the nodes to the edge server or leave the nodes to be executed locally. Timeline model is established to record arrival events of all tasks and execution completion events of the nodes. Online multi-workflow scheduling policy based on reinforcement learning is established, state space and action space of scheduling problem are defined, and reward function of the scheduling problem is designed. Algorithm based on policy gradient is designed to solve online multi-workflow scheduling problem for implementing the scheduling policy. Unloading decision and resource allocation are performed based on features extracted by graph convolution neural network. Current workflow and state of the server can be analyzed in real time, thereby reducing complexity and average completion time of all workflows.

### CROSS-REFERENCE TO RELATED APPLICATION

This patent application claims the benefit and priority of Chinese Patent Application No. 202210857988.8 filed with the China National Intellectual Property Administration on Jul. 20, 2022, the disclosure of which is incorporated by reference herein in its entirety as part of the present application.

### TECHNICAL FIELD

The present disclosure belongs to the field of mobile edge computing, and mainly relates to an online multi-workflow scheduling method based on reinforcement learning.

### BACKGROUND

Mobile Edge Computing (MEC) network deploys edge servers with certain computing capacity at the edge of the network, and provides higher quality of service by unloading computing tasks to the edge servers near the network edge of the local users. The network has obvious advantages such as low delay, strong security and reduced network congestion, which solves the problems of limited computing capacity and high delay in a conventional cloud computing mode. Effective and reasonable unloading decision and resource allocation will help to improve the performance of MEC network and bring considerable profits to enterprises.

However, the joint optimization problem of online unloading decision and resource allocation of workflow characterized by the Directed Acyclic Graph (DAG) in MEC network environment is a non-convex NP-hard problem. The conventional mathematical method to solve such problem has a large amount of calculation and high complexity, which brings a huge burden to MEC network. Therefore, there is also an attracted extensive attention of scholars at home and abroad to obtain better unloading decision and resource allocation in the mobile edge computing environment.

### SUMMARY

In order to solve the above problems, the present disclosure proposes an online multi- workflow scheduling method based on reinforcement learning.

The method includes the following steps:

S1, establishing a system model:

a mobile edge computing network includes a plurality of mobile devices and a plurality of edge servers, a processor frequency and a number of processor cores of the mobile devices are respectively represented as fₙ and cpuₙ, a processor frequency and a number of processor cores of the edge servers are respectively represented as fₘ and cpuₘ, and a bandwidth between the edge servers and a bandwidth between the mobile devices and the edge servers are both represented as B;

each mobile device generates independent tasks characterized by a DAG, and then each DAG is represented as a 2-tuple G=(V, E), where V=(v₁, . . . , vₖ, , v_{K}) represents nodes in the DAG, and E={eₖₗ|vₖ ∈ V, vₗ ∈ V} represents an edge that characterizes a connection relationship between the nodes, and the edge eₖₗ represents a constraint dependency relationship between the nodes, and the constraint dependency relationship indicates that the node vₗ starts execution only after the node vₖ completes execution; each node is characterized as a triple vₖ=(Wₖ,Dₖⁱ, Dₖ^{o}, where Wₖ represents a workload of the node vₖ, Dₖⁱ represents an input data size of the node vₖ, and Dₖ^{o} represents an output data size of the node vₖ; and both the mobile devices and the edge servers have their own waiting queues for storing the nodes to be executed on the mobile device or the edge server.

S2, establishing a node unloading rule:

the mobile device performs unloading in units of nodes, and selects to unload the nodes to the edge server or leave the nodes to be executed locally. A current node starts execution only after execution and data transmission of all predecessor nodes of the current node are completed. After a scheduling action is triggered, the scheduling policy proposed by the present disclosure selects a node to be allocated and determines the edge server or mobile device to which the node is to be allocated. The completion time of the node v k on the mobile device or the edge server is calculated by Formula (1):

$$F {T}_{{v}_{k}} = max ( p r {e}_{{v}_{k}} , avail ) + {T}_{e x e c} ( {v}_{k} ) \qquad ( 1 )$$

$$pr {e}_{{v}_{k}} = {max}_{{v}_{l} ∈ pre ( {v}_{k} )} ( F {T}_{{v}_{l}} + {T}_{tran} ( {v}_{l} , {v}_{k} ) ) \qquad ( 2 )$$

$${T}_{tran} ( {v}_{l} , {v}_{k} ) = \{ \begin{matrix}\begin{matrix}0 , nodes {v}_{l} and {v}_{k} are executed on the same \\ edge server or mobile device\end{matrix} \\ \begin{matrix}\frac{{D}_{l}^{o}}{B} , nodes {v}_{l} and {v}_{k} are executed \\ on different edge servers or mobile devices\end{matrix}\end{matrix} \qquad ( 3 )$$

$${T}_{e x e c} ( {v}_{k} ) = \{ \begin{matrix}\frac{{W}_{k}}{{f}_{n} * {cpu}_{n}} , \begin{matrix}the node {v}_{k} is executed \\ on the mobile device\end{matrix} \\ \frac{{W}_{k}}{{f}_{m} * c p {u}_{m}} , \begin{matrix}the node {v}_{k} is executed \\ on the edge server\end{matrix}\end{matrix} \qquad ( 4 )$$

where in Formula (1), avail represents the available time of the mobile device or the edge server, max(preᵥₖ, avail) represents that a larger value of preᵥₖ and avail are taken; Formula (2) represents a time when execution and output data transmission of all the predecessor nodes of the current node vₖ are completed, where FTᵥ_{ₗ} represents a time when the node vₗ completes execution, and maxᵥ_{ₗ}_{∈pre}(vₖ)(FTᵥ_{ₗ}+Tₜᵣₐₙ(Vₗ, Vₖ)) represents a maximum value of a sum of FTᵥ_{ₗ} and Tₜᵣₐₙ(vₗ, vₖ) for traversing all the predecessor nodes vₗ of the node vₖ; Formula (3) represents time for data transmission, and if the predecessor node and the current node are executed on the same mobile device or edge server, data transmission is not required, otherwise, the data transmission is required, and Formula (4) represents time for the execution of the node.

S3, establishing a timeline model:

the present disclosure provides a timeline model, which records arrival events of all DAG tasks and execution completion events of the nodes. An arrival process of the task on the mobile device obeys Poisson distribution with a parameter λ, that is, a task arrival rate is λ. An event closest to a current time on the timeline is continuously captured, and the current time is updated according to the captured event until a condition for triggering the scheduling action is met. The condition for triggering the scheduling action is that there is a schedulable node and the edge server or the mobile device to which the schedulable node belongs is idle. After the scheduling action is completed, the events on the timeline continue to be captured.

S4, establishing an online multi-workflow scheduling policy based on reinforcement learning:

it is necessary to define a state space and action space of a scheduling problem, design a reward function of the scheduling problem, and use a gradient policy for training with a goal of maximizing the expected reward, which specifically includes the following sub-steps:

S41, defining the state space:

under the environment of online multi-workflow scheduling characterized by the DAG, an agent interacting with the environment uses a graph convolution neural network to extract the features of all DAGs. Each node aggregates information of its child nodes from top to bottom through the graph convolution neural network, while the child nodes as the parent nodes are also aggregated by their corresponding parent nodes. An embedding vector of each node can be obtained by step-by-step aggregation of the messages, and the embedding vector of each node includes information about a critical path value of each node. At the same time, based on the embedding vectors of these nodes, the agent further performs aggregation to obtain an embedding vector of the DAG to which the node belongs, which includes information about remaining workload of the DAG. Thereafter, based on the embedding vectors of these DAGs, the agent further perfroms aggregation to obtain a global embedding vector, which includes information about global workload.

An environmental state obtained by the agent observing the environment is divided into two parts:

when selecting the node to be scheduled, the environment state O_{node} observed by the agent is expressed as Formula (5):

O_{node}=[E_{node}, E_{DAG}, E_{globa}, T_{stay}, T_{waste}, D_{i,o}, W_{node}, Wₚᵣₑ] (5)

where E_{node}, E_{DAG}, and E_{globa} represent the embedding vector of the node, the embedding vector of the DAG to which the node belongs, and the global embedding vector, respectively; T_{stay} represents a staying time of the DAG to which the node belongs in the environment; T_{waste} represents a duration that the node will wait for execution on the mobile device or the edge server and that the mobile device or the edge server will wait; D_{i,o} represents input and output data of the node; and W_{node} represents the workload of the node; Wₚᵣₑ represents a sum of the workloads of all the parent nodes of the node.

when selecting a server to be allocated, the environment state Oₛₑᵣᵥₑᵣ observed by the agent is expressed as Formula (6):

Oₛₑᵣᵥₑᵣ =[stₚₑᵣ, stₛₑᵣᵥₑᵣ, T_{exec}, num_{child}, W_{child}] (6)

where stₚᵣₑ represents a time when data transmission of predecessor nodes of the node is completed; stₛₑᵣᵥₑᵣ represents an available time of each server; T_{exec} represents an execution time of the node on each server; num_{child} represents a total number of all child nodes and all descendant nodes of the node; and W_{child} represents a sum of the workloads of all the child nodes and all the descendant nodes of the node;

S42, defining the action space:

the policy proposed by the present disclosure divides the action into two parts. The agent inputs the observed states O_{node} and Oₛₑᵣᵥₑᵣ into two neural networks (i. e. a policy network) based on the gradient policy, respectively, so as to select the node node to be scheduled this time from the nodes to be scheduled and select the server server to be allocated to the node from the available servers, which is expressed by Formula (7):

A=[node, server] (7)

where A represents the defined action space.

S43, defining the reward function:

in an online multi-workflow scheduling process, each action obtains an immediate reward to evaluate quality of the action, and an average completion time of all DAG tasks is taken as a final long-term optimization goal. According to Little's law, the immediate reward is set as an existence time of all DAG tasks in the environment during a period from the start of the current action to the trigger of the next action, which is expressed by Formula (8) and (9):

R=−ΣT_{stay}(G) (8)

T_{stay}(G)=min (T_{now}, T_{finish}(G))−max (Tₚᵣₑ, Tₐᵣᵣᵢᵥₑ(G)) (9)

where T_{now} represents the current time; T_{finish}(G) represents a completion time of a workflow G, Tₚᵣₑ represents a time when a last action is executed, Tₐᵣᵣᵢᵥₑ(G) represents an arrival time of the workflow G, min (T_{now}, T_{finish}(G)) represents a minimum value of T_{now} and T_{finish}(G) ; and max(Tₚᵣₑ, Tₐᵣᵣᵢᵥₑ(G)) represents a maximum value of Tₚᵣₑ and Tₐᵣᵣᵢᵥₑ(G).

S44, formalizing the problem:

the online multi-workflow scheduling policy can take the neural network model based on the gradient policy into account, a main goal of which is to maximize a cumulative reward of all actions, which is expressed by Formula (10):

Maximize: Σₖ₌₀^{T}Rₖ (10)

where T indicates T actions in implementation of the policy, k indicates a k-th action, and Rk indicates a reward of the k-th action.

Because a goal of the gradient policy is to maximize the reward, gradient ascent is performed on neural network parameters to learn the parameters.

S5, implementing the policy:

The present disclosure designs a policy gradient-based algorithm for solving online multi- workflow scheduling problems (PG-OMWS) for implementing the policy, and the detailed process of implementing the policy is as follows:

(1) in the policy implementation stage, first, the environmental parameters and network parameters are initialized. The environmental parameters mainly include an execution queue length, the bandwidth between the mobile device and the edge server, and a DAG task structure in the environment and in an upcoming environment. The network parameters mainly include the network parameters in two policy networks and the graph convolution neural network. Then the agent observes basic features of each node in the environment, and feeds the basic features to the graph convolution neural network for two aggregations to obtain E_{node}, and then the aggregation is performed to obtain E_{DAG} according to these E_{node}, and the aggregation is again performed to obtain E_{globa} according to all E_{DAG}, to obtain O_{node} and Oₛₑᵣᵥₑᵣ in conjunction with the current environment. The node to be allocated for the action and the server to be allocated to the node are selected. The completion events of the node are recorded in the timeline, and the reward of the action is calculated at the same time. The environmental state, the action and the reward observed every time will be saved. Subsequently, it is determined whether the condition for triggering the scheduling action is met, if the condition is met, the scheduling action continues to be triggered, and if the condition is not met, the event closest to the current time on the timeline is captured, and the current time is updated according to the event, until the condition for triggering the scheduling action is met again. A cycle of scheduling action and capturing timeline events is repeated continuously until all DAG tasks in the environment complete execution.

(2) in the training stage, according to the environment state, the action and the reward saved previously, the agent uses the gradient policy to update each network parameter by Formula (11) to obtain a final workflow scheduling policy:

θ←θ+αΣₖ₌₀^{T}∇_{θ} ln π_{θ}(oₖ, aₖ)rₖ (11)

where θ represents the network parameter, a represents a learning rate, T represents T actions in the implementation of the policy, k represents the k-th action, π_{θ}(oₖ, aₖ) represents a probability that the neural network with 0 as the parameter takes the action aₖ in the environmental state oₖ, rₖ represents a comprehensive reward obtained by further attenuation based on the immediate reward, V 8 In rc a (o k , a k)r k represents a gradient of lnrc e (s k , a k)r k , and Σₖ₌₀^{T}∇_{θ} ln π_{θ}(oₖ, aₖ)rₖ represents an accumulation of the gradients obtained from all actions;

(3) in the policy execution stage, when a workflow dynamically arrives in the environment, the edge server or the mobile device that executes the node in the workflow is selected by the final workflow scheduling policy as the server that executes the node to execute and complete the nodes in the workflows in sequence.

The method has the following beneficial effect. The graph convolution neural network is used to extract the structural feature of the workflow, and unloading decision and resource allocation are performed based on the extracted features. A solution combining the gradient policy is proposed for the first time under the online multi-workflow scheduling environment of mobile edge computing. When a workflow dynamically arrives in the environment, the present disclosure can analyze the current workflow and the state of the server in real time, and schedule the nodes of the workflow to a server for execution. This method has low complexity and reduces the average completion time of all workflows as much as possible.

### BRIEF DESCRIPTION OF THE DRAWINGS

FIG. 1 is a flowchart of an online multi-workflow scheduling policy based on reinforcement learning according to the present disclosure.

FIG. 2 is a comparison diagram of experimental results of the present disclosure with FIFO method, SJF method, Random method, LocalEx method and EdgeEx method under the influence of the task arrival rate X.

FIG. 3 is a comparison diagram of experimental results of the present disclosure with FIFO method, SJF method, Random method, LocalEx method and EdgeEx method under the influence of the number of processor cores of the edge server.

FIG. 4 is a comparison diagram of experimental results of the present disclosure with FIFO method, SJF method, Random method, LocalEx method and EdgeEx method under the influence of the number of processor cores of the mobile device.

FIG. 5 is a comparison diagram of experimental results of the present disclosure with FIFO method, SJF method, Random method, LocalEx method and EdgeEx method under the influence of the number of the edge servers.

FIG. 6 is a comparison diagram of experimental results of the present disclosure with FIFO method, SJF method, Random method, LocalEx method and EdgeEx method under the influence of the number of the mobile devices.

### DETAILED DESCRIPTION OF THE EMBODIMENTS

In order to make the purpose, technical scheme and advantages of the present disclosure more clear, the present disclosure will be further described in detail with the accompanying drawings.

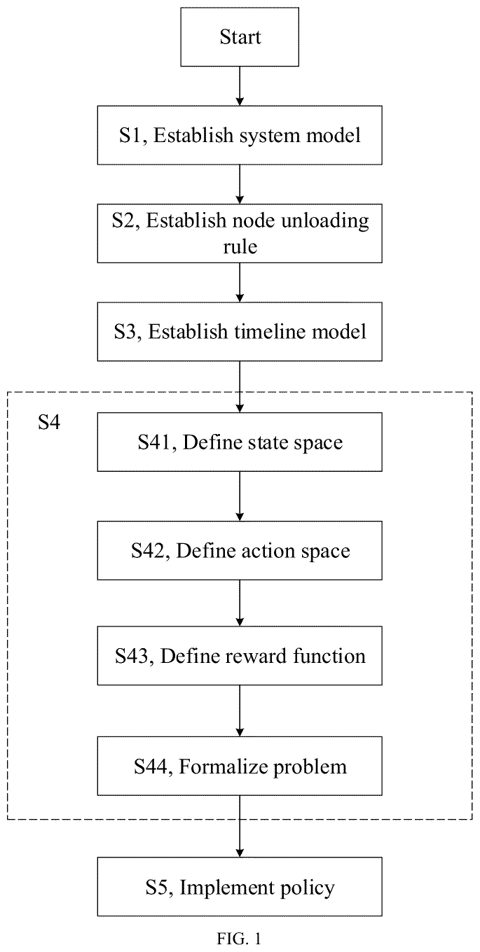

As shown in FIG. 1, the present disclosure provides an online multi-workflow scheduling method based on reinforcement learning including the following steps:

S1, a system model is established:

A mobile edge computing network includes a plurality of mobile devices and a plurality of edge servers, the processor frequency and the number of processor cores of the mobile devices are respectively represented as and cpun, the processor frequency and the number of processor cores of the edge servers are respectively represented as fm and cpum, and the bandwidth between the edge servers and the bandwidth between the mobile devices and the edge servers are both represented as B;

each mobile device generates independent tasks characterized by a DAG, and then each DAG is represented as a 2-tuple G=(V, E), where V=(v₁, . . . , vₖ, . . . , v_{K}) represents nodes in the DAG, and E={eₖₗ|vₖ ∈ V, vₗ ∈ V} represents an edge that characterizes a connection relationship between the nodes, and the edge eₖₗ represents a constraint dependency relationship between the nodes, that is, the node vₗ only starts execution after the node vₖ completes execution; each node is characterized as a triple vₖ=(Wₖ, Dₖⁱ, Dₖ^{o}), where Wₖ represents a workload of the node vₖ, Dₖⁱ represents an input data size of the node vₖ, and Dₖ^{o} represents an output data size of the node vₖ; and both the mobile devices and the edge servers have their own waiting queues for storing the nodes to be executed on the mobile device or the edge server.

S2, a node unloading rule is established:

The mobile device performs unloading in units of nodes, and selects to unload the nodes to the edge server or leave the nodes to be executed locally. The current node starts execution only after the execution and data transmission of all predecessor nodes of the current node are completed. After a scheduling action is triggered, the scheduling policy proposed by the present disclosure selects a node to be allocated and determines the edge server or mobile device to which the node is to be allocated. The completion time of the node vₖ on the mobile device or the edge server is calculated by Formula (1):

$$F {T}_{{v}_{k}} = max ( p r {e}_{{v}_{k}} , avail ) + {T}_{e x e c} ( {v}_{k} ) \qquad ( 1 )$$

$$pr {e}_{{v}_{k}} = {max}_{{v}_{l} ∈ pre ( {v}_{k} )} ( F {T}_{{v}_{l}} + {T}_{tran} ( {v}_{l} , {v}_{k} ) ) \qquad ( 2 )$$

$${T}_{tran} ( {v}_{l} , {v}_{k} ) = \{ \begin{matrix}\begin{matrix}\begin{matrix}0 , nodes {v}_{l} and {v}_{k} are executed \\ on the same edge server or mobile device\end{matrix} \\ \frac{{D}_{l}^{o}}{B} , nodes {v}_{l} and {v}_{k} are executed\end{matrix} \\ on different edge servers or mobile devices\end{matrix} \qquad ( 3 )$$

$${T}_{e x e c} ( {v}_{k} ) = \{ \begin{matrix}\frac{{W}_{k}}{{f}_{n} * {cpu}_{n}} , \begin{matrix}the node {v}_{k} is executed on \\ the mobile device\end{matrix} \\ \frac{{W}_{k}}{{f}_{m} * c p {u}_{m}} , \begin{matrix}the node {v}_{k} is executed \\ on the edge server\end{matrix}\end{matrix} \qquad ( 4 )$$

wherein in Formula (1), avail represents the available time of the mobile device or the edge server; Formula (2) represents the time when the execution and output data transmission of all the predecessor nodes of the current node vₖ are completed; Formula (3) represents the time for data transmission., and if the predecessor node and the current node are executed on the same mobile device or edge server, data transmission is not required, otherwise, the data transmission is required; and Formula (4) represents the time for the execution of the node.

S3, a timeline model is established:

The present disclosure provides a timeline model, which records arrival events of all DAG tasks and execution completion events of the nodes. An arrival process of the task on the mobile device obeys Poisson distribution with a parameter X, an event closest to the current time on the timeline is continuously captured, and the current time is updated according to the captured event until the condition for triggering the scheduling action is met. The condition for triggering the scheduling action is that there is a schedulable node and the edge server or the mobile device to which the schedulable node belongs is idle. After the scheduling action is completed, the events on the timeline continue to be captured.

S4, an online multi-workflow scheduling policy based on reinforcement learning: it is necessary to define a state space and action space of a scheduling problem, design a reward function of the scheduling problem, and use a gradient policy for training with a goal of maximizing the expected reward, which specifically includes the following sub-steps:

S41, the state space is defined:

Under the environment of online multi-workflow scheduling characterized by the DAG, an agent interacting with the environment uses the graph convolution neural network to extract the features of all DAGs. Each node aggregates information of its child nodes from top to bottom, and at the same time, the child nodes as the parent nodes are also aggregated by their own parent nodes. An embedding vector of each node can be obtained by step-by-step aggregation of the messages, and the embedding vector of each node includes information about a critical path value of each node. At the same time, based on the embedding vectors of these nodes, the agent further performs aggregation to obtain an embedding vector of the DAG to which the node belongs, which includes information about remaining workload of the DAG. Thereafter, based on the embedding vectors of these DAGs, the agent further performs aggregation to obtain a global embedding vector, which includes information about global workload. With the embedding vector of the node, the agent can determine the workload along the downward critical path of the node, and with the embedded vectors of the DAG and the global embedded vector, the agent can identify the relative size of the remaining workload of the operation.

An environmental state obtained by the agent observing the environment is divided into two parts:

when selecting the node to be scheduled, the environment state O_{node} observed by the agent is expressed as Formula (5):

O_{node}=[E_{node}, E_{DAG}, E_{globa}, T_{stay}, T_{waste}, D_{i,o}, W_{node}, Wₚᵣₑ] (5)

where E_{node}, E_{DAG}, and E_{globa} represent the embedding vector of the node, the embedding vector of the DAG to which the node belongs, and the global embedding vector, respectively; T_{stay} represents a staying time of the DAG to which the node belongs in the environment; T_{waste} represents a duration that the node will wait for execution on the mobile device or the edge server and that the mobile device or the edge server will wait; D_{i,o} represents input and output data of the node; and W_{node} represents the workload of the node; Wₚᵣₑ represents a sum of the workloads of all the parent nodes of the node.

when selecting the server to be allocated, the environment state Oₛₑᵣᵥₑᵣ observed by the agent is expressed as Formula (6):

Oₛₑᵣᵥₑᵣ =[stₚₑᵣ, stₛₑᵣᵥₑᵣ, T_{exec}, num_{child}, W_{child}] (6)

where stₚᵣₑ represents the time when data transmission of predecessor nodes of the node is completed; stₛₑᵣᵥₑᵣ represents the available time of each server; T_{exec} represents the execution time of the node on each server; num_{child} represents the total number of all child nodes and all descendant nodes of the node; W_{child} represents a sum of the workloads of all the child nodes and all the descendant nodes of the node.

S42, the action space is defined:

The policy proposed by the present disclosure divides the action into two parts. The agent inputs the observed states O_{node} and Oₛₑᵣᵥₑᵣ into two neural networks based on the gradient policy, respectively, so as to select the node node to be scheduled this time from the nodes to be scheduled and select the server server to be allocated to the node from the available servers, which is expressed by Formula (7):

A=[node, server] (7)

where A represents the defined action space.

S43, the reward function is defined:

In the online multi-workflow scheduling process, each action obtains an immediate reward to evaluate the quality of the action, and the average completion time of all DAG tasks is taken as a final long-term optimization goal. According to Little's law, the immediate reward is set as the existence time of all DAG tasks in the environment during the period from the start of the current action to the trigger of the next action, which is expressed by Formula (8) and (9):

R=−ΣT_{stay}(G) (8)

T_{stay}(G)=min (T_{now}, T_{finish}(G))−max (Tₚᵣₑ, Tₐᵣᵣᵢᵥₑ(G)) (9)

where T_{now} represents the current time; T_{finish}(G) represents a completion time of a workflow G, Tₚᵣₑ represents a time when a last action is executed, Tₐᵣᵣᵢᵥₑ(G) represents the arrival time of the workflow G, min (T_{now}, T_{finish}(G)) represents a minimum value of T_{now} and T_{finish}(G); and max(Tₚᵣₑ, Tₐᵣᵣᵢᵥₑ(G)) represents a maximum value of Tₚᵣₑ and Tₐᵣᵣᵢᵥₑ(G). According to Little's law, because the arrival rate of tasks is determined by the outside world, the shorter the tasks stay in the environment, the less the average number of tasks in the environment, and the lower the average completion time of all tasks. Therefore, the immediate reward can evaluate the quality of the action better.

S44, the problem is formalized:

The online multi-workflow scheduling policy can take the neural network model based on the gradient policy into account, the main goal of which is to maximize a cumulative reward of all actions, which is expressed by Formula (10):

Maximize: Σₖ₌₀^{T}Rₖ (10)

where T indicates T actions in the implementation of the policy, k indicates the k-th action, and Rₖ indicates the reward of the k-th action.

Because the goal of the gradient policy is to maximize the reward, gradient ascent is performed on neural network parameters to learn the parameters.

S5, the policy is implemented:

The present disclosure designs a policy gradient-based algorithm for solving online multi- workflow scheduling problems (PG-OMWS) for implementing the policy, and the detailed process of implementing the policy is as follows:

(1) in the policy implementation stage, first, the environmental parameters and network parameters are initialized. The environmental parameters mainly include an execution queue length, the bandwidth between the mobile device and the edge server, and a DAG task structure in the environment and in an upcoming environment. The network parameters mainly include the network parameters in two policy networks and the graph convolution neural network. Then the agent observes the basic features of each node in the environment, and feeds the basic features to the graph convolution neural network for two aggregations to obtain E_{node}, and then the aggregation is performed to obtain E_{DAG} according to these E_{node}, and the aggregation is again performed to obtain E_{globa} according to all E_{DAG}, to obtain O_{node} and Oₛₑᵣᵥₑᵣ in conjunction with the current environment. The node to be allocated for this action and the server to be allocated to this node are selected. The completion events of the node are recorded in the timeline, and the reward of the action is calculated at the same time. The environmental state, the action and the reward observed every time will be saved. Subsequently, it is determined whether the condition for triggering the scheduling action is met, if the condition is met, the scheduling action continues to be triggered, and if not, the event closest to the current time on the timeline is captured, and the current time is updated according to the event, until the condition for triggering the scheduling action is met again. A cycle of scheduling action and capturing timeline events is repeated continuously until all DAG tasks in the environment complete execution.

(2) in the training stage, according to the environment state, the action and the reward saved previously, the agent uses the gradient policy to update each network parameter by Formula (11) to obtain a final workflow scheduling policy:

θ←θ+αΣₖ₌₀^{T}∇_{θ} ln π_{θ}(oₖ, aₖ)rₖ (11)

where θ represents the network parameter, a represents a learning rate, T represents T actions in the implementation of the policy, k represents the k-th action, m e (o k , a k) represents a probability that the neural network with 0 as the parameter takes the action a k in the environmental state oₖ, rₖ represents a comprehensive reward obtained by further attenuation based on the immediate reward, 59 _{θ} ln π_{θ}(oₖ, aₖ)rₖ represents a gradient of lnπ_{θ}(sₖ, aₖ)rₖ, and Σₖ₌₀^{T}∇_{θ} ln π_{θ}(oₖ, aₖ)rₖ represents an accumulation of the gradients obtained from all actions;

(3) in the policy execution stage, when a workflow dynamically arrives in the environment, the edge server or the mobile device that executes the node in the workflow is selected by the final workflow scheduling policy as the server that executes the node to execute and complete the nodes in the workflows in sequence.

Embodiment

The steps of this embodiment are the same as those of the specific implementation mentioned above, which are not described in detail here.

Preferably, the number of mobile devices in S1 is 3, the number of processor cores of the mobile devices is cpuₙ=4, and the processor frequency of the mobile devices is fₙ=2.0 GHZ. The number of edge servers is 6, the number of processor cores of the edge servers is cpuₘ=6, and the processor frequency of the edge servers is fₘ,=2.5 GHZ. The bandwidth between the mobile device and the edge server, and the bandwidth between the edge server and another edge server are randomly selected between [10,100] MB/s. There are 10 DAG tasks in the environment initially, and then 15 DAG tasks are generated online by the mobile devices. The workload of nodes in the DAG is randomly selected between [10,100] GHZ·S. The output data of a node is set to 0.1 times the workload in units of MB, and the input data of the node is the sum of the output data of all its parent nodes.

Preferably, the Poisson distribution parameter in S2, i. e., the task arrival rate λ, is set to 5.

Preferably, the neural network hidden layer structures through which the graph convolution neural network in S5 aggregates are all the same, all of which have two hidden layers with 16 and 8 neurons respectively. The hidden layer structures of the two policy networks are also the same, both of which have three hidden layers with 32, 16 and 8 neurons respectively. In the present disclosure, an Adam optimizer is used to update the target network, the activation function uses leakyRelu, the learning rate is set to 0.0003, and the reward attenuation coefficient 7 is set to 1.

The implementation and implementation results of the comparison method are shown as follows.

In order to evaluate the effectiveness of the proposed method framework, five other methods (SJF, FIFO, Random, LocalEx, EdgeEx) are used for comparison. These five methods are briefly introduced hereinafter. (1) SJF: This method selects the node to be executed according to the principle of short job priority, and takes the sum of the workloads of nodes in the DAG as the workload of the DAG. The less the workload, the earlier it is scheduled, and the edge server or mobile device with the earliest completion time to execute the node is selected as the server to execute the node.

(2) FIFO: This method selects the node to be executed according to the principle of first- in and first-out, and selects the edge server or the mobile device with the earliest completion time to execute the node as the server to execute the node.

(3) LocalEx: This method always selects the mobile device to execute the nodes, and the order of executing nodes follows the principle of first-in and first-out.

(4) EdgeEx: This abbreviation indicates that the node is always unloaded to the edge server. That is, except for the start node and the end node, this method always selects the edge server with the earliest completion time to execute the node, and the order of executing nodes follows the principle of first-in and first-out.

(5) Random: This method randomly selects the node and the edge server or the mobile device allocated at this time as the server executing the node.

The present disclosure evaluates and analyzes the influence of the task arrival rate, the number of processor cores of the edge servers, the number of processor cores of the mobile devices, the number of edge servers and the number of mobile devices on the average completion time of all tasks.

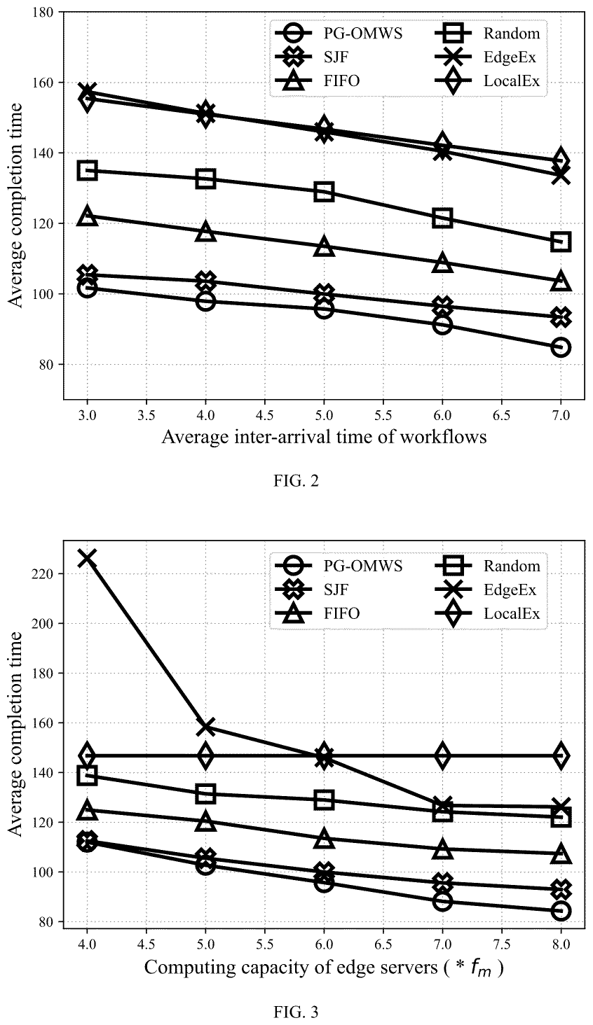

In order to test the influence of different task inter-arrival times on performance, the task inter-arrival time is changed from 3 to 7 unit times in increments of 1. The average completion time obtained by the six methods is shown in FIG. 2. It is observed from FIG. 2 that compared with other methods, the method implemented by PG-OMWS according to the present disclosure has a lower average completion time, and the average completion time gradually decreases with the increase of task inter-arrival time. The reason is that with the increase of task inter-arrival time, the number of nodes that need to be processed at the same time decreases, thus reducing the average completion time.

In order to study the influence of computing capacity of the edge server on performance, the number of processor cores of the edge server, i. e., the number of cores of the CPU, is changed from 4 to 8 in increments of 1. The average completion time obtained by the six methods in the experiment is shown in FIG. 3. It can be seen that the method implemented by PG-OMWS according to the present disclosure can obtain the lowest average completion time, and the average completion time gradually decreases with the increase of the number of cores of the CPU. The reason is that the increase of the number of cores of the CPU greatly shortens the processing delay of nodes, thus shortening the average completion time.

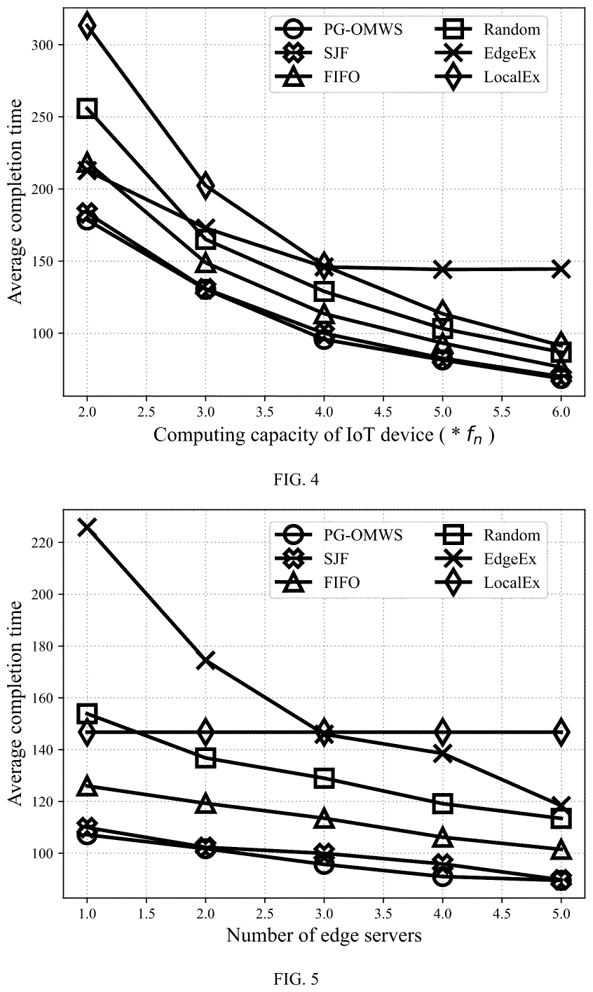

In order to study the influence of computing capacity of the mobile devices, the number of cores of the CPU of the mobile devices is changed from 2 to 6 in increments of 1. The average completion time obtained by the six methods is shown in FIG. 4. Compared with other methods, the method implemented by PG-OMWS according to the present disclosure can obtain a lower average completion time. With the increase of the number of cores of the CPU of the mobile devices, the average completion time gradually decreases. The reason is that with the increase of the number of cores of the CPU of the mobile devices, the processing speed of nodes is greatly accelerated, thus shortening the average completion time.

In order to study the influence of different number of edge servers on the performance of the method, the number of edge servers is set to 1 to 5 in increments of 1. The average completion time obtained by six methods is shown in FIG. 5. The result of FIG. 5 shows that the method implemented by PG-OMWS according to the present disclosure is always superior to other methods in the case that the number of edge servers varies. The average completion time decreases with the increase of the number of edge servers. The reason is that more edge servers provide more computing resources, thus reducing the average completion time. In addition, the curve of the LocalEx method is flat, since the LocalEx method executes all nodes locally, regardless of the number of edge servers.

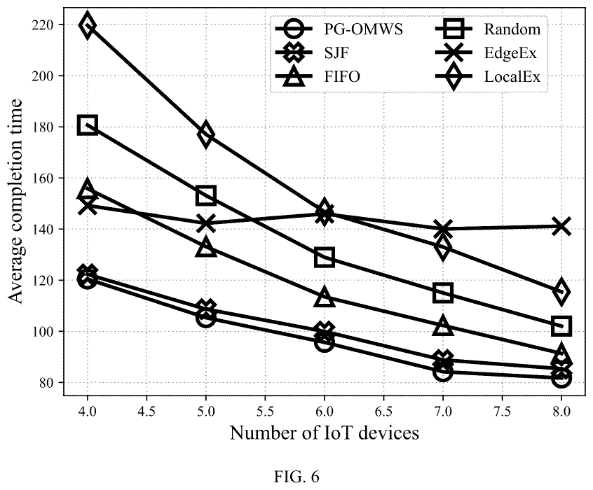

In order to study the influence of the number of mobile devices on performance, experiments are carried out based on different numbers of mobile devices. The number of edge servers is set to 4 to 8 in increments of 1. The related results are shown in FIG. 6. It can be seen from FIG. 6 that the method implemented by PG-OMWS according to the present disclosure is always superior to other methods in the case that the number of mobile devices varies. With the increase of the number of mobile devices, the average completion time gradually decreases. The reason is that more mobile devices provide more computing resources, thus shortening the average completion time. In addition, when the number of mobile devices increases excessively, the EdgeEx method will not continue to decrease accordingly, since the EdgeEx method unloads most nodes to the edge server, regardless of the number of mobile devices.

What is claimed is:

1. An online multi-workflow scheduling method based on reinforcement learning, comprising:
S1, establishing a system model:
wherein a mobile edge computing network comprises a plurality of mobile devices and a plurality of edge servers, a processor frequency and a number of processor cores of the mobile devices are respectively represented as fₙ and cpuₙ, a processor frequency and a number of processor cores of the edge servers are respectively represented as fₘ and cpuₘ, and a bandwidth between the edge servers and a bandwidth between the mobile devices and the edge servers are both represented as B;
independent tasks generated online by each mobile device are characterized by a Directed Acyclic Graph (DAG), and then each Directed Acyclic Graph (DAG) is represented as a 2-tuple G=(V, E), wherein V=(v₁, . . . , vₖ, . . . , v_{K}) represents nodes in the DAG, and E={eₖₗ|vₖ ∈ V, vₗ ∈V} represents an edge that characterizes a connection relationship between the nodes, and the edge eₖₗ represents a constraint dependency relationship between the nodes, and the constraint dependency relationship indicates that the node vₗ starts execution only after the node vₖ completes execution; and
each node is characterized as a triple vₖ=(Wₖ, Dₖⁱ, Dₖ^{o}), wherein Wₖ represents a workload of the node vₖ, Dₖ represents an input data size of the node vₖ, and Dₖ^{o} represents an output data size of the node vₖ;
S2, establishing a node unloading rule:
wherein after a scheduling action is triggered, a scheduling policy selects a node to be allocated and determines the edge server or mobile device to which the node is to be allocated;
S3, establishing a timeline model:
wherein the timeline model records arrival events of all DAG tasks and execution completion events of the nodes; and
an arrival process of the task on the mobile device obeys Poisson distribution with a parameter λ, wherein a task arrival rate is λ, an event closest to a current time on the timeline is continuously captured, the current time is updated according to the captured event until a condition for triggering the scheduling action is met; after the scheduling action is completed, the events on the timeline continue to be captured;
S4, establishing an online multi-workflow scheduling policy based on reinforcement learning:
wherein a state space and action space of a scheduling problem are defined, a reward function of the scheduling problem is designed, and a gradient policy is used for training;
S41, defining the state space:
wherein an environmental state obtained by an agent observing environment is divided into two parts:
when selecting the node to be scheduled, the environment state O_{node} observed by the agent is expressed as Formula (5):
O_{node}=[E_{node}, E_{DAG}, E_{globa}, T_{stay}, T_{waste}, D_{i,o}, W_{node}, Wₚᵣₑ] (5)
wherein E_{node}, E_{DAG}, and E_{globa} represent an embedding vector of the node, an embedding vector of the DAG to which the node belongs, and a global embedding vector, respectively; T_{stay} represents a staying time of the DAG to which the node belongs in the environment; T_{waste} represents a duration that the node will wait for execution on the mobile device or the edge server and that the mobile device or the edge server will wait; D_{i,o} represents input and output data of the node; and W_{node} represents the workload of the node; Wₚᵣₑ represents a sum of the workloads of all parent nodes of the node; and
when selecting a server to be allocated, the environment state Oₛₑᵣᵥₑᵣ observed by the agent is expressed as Formula (6):
Oₛₑᵣᵥₑᵣ =[stₚₑᵣ, stₛₑᵣᵥₑᵣ, T_{exec}, num_{child}, W_{child}] (6)
wherein stₚᵣₑ represents a time when data transmission of predecessor nodes of the node is completed; stₛₑᵣᵥₑᵣ represents an available time of each server; Texec represents an execution time of the node on each server; num_{child} represents a total number of all child nodes and all descendant nodes of the node; and W_{child} represents a sum of the workloads of all the child nodes and all the descendant nodes of the node;
S42, defining the action space:
wherein the agent inputs the observed states O_{node} and Oₛₑᵣᵥₑᵣ into two neural networks based on the gradient policy, respectively, to select the node node to be scheduled this time from the nodes to be scheduled and select the server server to be allocated to the node from the available servers, which is expressed by Formula (7):
A=[node, server] (7)
wherein A represents the defined action space;
S43, defining the reward function:
wherein an immediate reward is set as an existence time R of all DAG tasks in the environment during a period from the start of a current action to the trigger of a next action, which is expressed by Formulas (8) and (9):
R=−ΣT_{stay}(G) (8)
T_{stay}(G)=min (T_{now}, T_{finish}(G))−max (Tₚᵣₑ, Tₐᵣᵣᵢᵥₑ(G)) (9)
where T_{now} represents the current time; T_{finish}(G) represents a completion time of a workflow G, Tₚᵣₑ represents a time when a last action is executed, Tₐᵣᵣᵢᵥₑ(G) represents an arrival time of the workflow G, min (T_{now}, T_{finish}(G)) represents a minimum value of T_{now} and T_{finish}(G) ; and max(Tₚᵣₑ, Tₐᵣᵣᵢᵥₑ(G)) represents a maximum value of Tₚᵣₑ and Tₐᵣᵣᵢᵥₑ(G).
S44, formalizing the problem:
wherein for the online multi-workflow scheduling policy, a main goal of the neural network model based on the gradient policy is to maximize a cumulative reward of all actions, which is expressed by Formula (10):
Maximize: Σₖ₌₀^{T}Rₖ (10)
wherein T indicates T actions in implementation of the policy, k indicates a k-th action, and Rₖ indicates a reward of the k-th action; and
gradient ascent is performed on neural network parameters to learn the parameters;
S5, implementing the policy:
wherein (1) first, environmental parameters and network parameters are initialized; then the agent observes basic features of each node in the environment, and feeds the basic features to a graph convolution neural network for two aggregations to obtain E_{node}, and then the aggregation is performed to obtain E_{DAG} according to these E_{node}, and the aggregation is performed to obtain E_{globa} according to all E_{DAG}, to obtain O_{node} and Oₛₑᵣᵥₑᵣ in conjunction with the current environment; the node to be scheduled for the action and the server to be allocated to the node are selected, the completion events of the node are recorded in the timeline, and the reward of the action is calculated at a same time; and the environmental state, the action and the reward observed every time are saved;
subsequently, it is determined whether the condition for triggering the scheduling action is met, if the condition is met, the scheduling action continues to be triggered, and if the condition is not met, the event closest to the current time on the timeline is captured, and the current time is updated according to the event, until the condition for triggering the scheduling action is met again;
and a cycle of scheduling action and capturing timeline events is repeated continuously until all DAG tasks in the environment complete execution;
(2) according to the environment state, the action and the reward saved previously, the agent uses the gradient policy to update each network parameter by Formula (11) to obtain a final workflow scheduling policy:
θ←θ+αΣₖ₌₀^{T}∇_{θ} ln π_{θ}(oₖ, aₖ)rₖ (11)
wherein θ represents the network parameter, a represents a learning rate, T represents T actions in the implementation of the policy, k represents the k-th action, m e (o k , a k) represents a probability that the neural network with θ as the parameter takes the action aₖ in the environmental state oₖ, rₖ represents a comprehensive reward obtained by further attenuation based on the immediate reward R, ∇_{θ} ln π_{θ}(oₖ, aₖ)rₖ represents a gradient of ln π_{θ}(oₖ, aₖ)rₖ , and Σₖ₌₀^{T}∇_{θ} ln π_{θ}(oₖ, aₖ)rₖ represents an accumulation of the gradients obtained from all actions; and
when a workflow dynamically arrives in the environment, the edge server or the mobile device that executes the node in the workflow is selected by the final workflow scheduling policy as the server that executes the node to execute and complete the nodes in the workflows in sequence.

2. The online multi-workflow scheduling method based on reinforcement learning according to claim 1, wherein both the mobile devices and the edge servers in step Si have their own waiting queues for storing the nodes to be executed on the mobile device or the edge server.

3. The online multi-workflow scheduling method based on reinforcement learning according to claim 1, wherein the mobile device in step S2 performs unloading in units of nodes, and selects to unload the nodes to the edge server or leave the nodes to be executed locally.

4. The online multi-workflow scheduling method based on reinforcement learning according to claim 1, wherein in step S2, a current node starts execution only after execution and data transmission of all predecessor nodes of the current node are completed.

5. The online multi-workflow scheduling method based on reinforcement learning according to claim 1, wherein in step S2, the completion time of the node vₖ on the mobile device or the edge server is calculated by Formula (1):
$$F {T}_{{v}_{k}} = max ( p r {e}_{{v}_{k}} , avail ) + {T}_{e x e c} ( {v}_{k} ) \qquad ( 1 )$$
$$pr {e}_{{v}_{k}} = {max}_{{v}_{l} ∈ pre ( {v}_{k} )} ( F {T}_{{v}_{l}} + {T}_{tran} ( {v}_{l} , {v}_{k} ) ) \qquad ( 2 )$$
$${T}_{tran} ( {v}_{l} , {v}_{k} ) = \{ \begin{matrix}\begin{matrix}\begin{matrix}0 , nodes {v}_{l} and {v}_{k} are executed \\ on the same edge server or mobile device\end{matrix} \\ \frac{{D}_{l}^{o}}{B} , nodes {v}_{l} and {v}_{k} are executed\end{matrix} \\ on different edge servers or mobile devices\end{matrix} \qquad ( 3 )$$
$${T}_{e x e c} ( {v}_{k} ) = \{ \begin{matrix}\frac{{W}_{k}}{{f}_{n} * {cpu}_{n}} , \begin{matrix}the node {v}_{k} is executed on \\ the mobile device\end{matrix} \\ \frac{{W}_{k}}{{f}_{m} * c p {u}_{m}} , \begin{matrix}the node {v}_{k} is executed \\ on the edge server\end{matrix}\end{matrix} \qquad ( 4 )$$
wherein in Formula (1), avail represents the available time of the mobile device or the edge server, max(pre vk , avail) represents that a larger value of preᵥ_{ₖ} and avail are taken;
Formula (2) represents a time when execution and output data transmission of all the predecessor nodes of the current node vₖ are completed, wherein FTᵥ_{ₗ} represents a time when the node vₗ completes execution, and maxᵥ_{ₗ}_{∈pre(v}_{ₖ}₎(FTᵥ_{ₗ}+Tₜᵣₐₙ(vₗ, vₖ)) represents a maximum value of a sum of FTᵥ_{ₗ} and Tₜᵣₐₙ(vₗ, vₖ) for traversing all the predecessor nodes vₗ of the node vₖ;
Formula (3) represents time for data transmission, and if the predecessor node and the current node are executed on the same mobile device or edge server, data transmission is not required, otherwise, the data transmission is required, wherein B represents the bandwidth between the edge servers and the bandwidth between the mobile devices and the edge servers, and Dₗ^{o} represents the output data size of the node vₗ; and Formula (4) represents time for the execution of the node, wherein fₙ and cpuₙ represent the processor frequency and the number of processor cores of the mobile devices, respectively, and fₘ and cpuₘ represent the processor frequency and the number of processor cores of the edge servers, respectively.

6. The online multi-workflow scheduling method based on reinforcement learning according to claim 1, wherein the condition for triggering the scheduling action in step S3 is that there is a schedulable node and the edge server or the mobile device to which the schedulable node belongs is idle.

7. The online multi-workflow scheduling method based on reinforcement learning according to claim 1, wherein under the environment of online multi-workflow scheduling characterized by the DAG in step S4, the agent interacting with the environment uses the graph convolution neural network to extract the features of all DAGs.

8. The online multi-workflow scheduling method based on reinforcement learning according to claim 1, wherein in step S41, each node aggregates information of its child nodes from top to bottom through the graph convolution neural network, while the child nodes as the parent nodes are also aggregated by their corresponding parent nodes to obtain the embedding vector of each node comprising information about a critical path value of each node;
based on the embedding vectors of these nodes, the agent further performs aggregation to obtain the embedding vector of the DAG to which the node belongs comprising information about remaining workload of the DAG; and
based on the embedding vectors of these DAGs, the agent further performs aggregation to obtain the global embedding vector comprising information about global workload.

9. The online multi-workflow scheduling method based on reinforcement learning according to claim 1, wherein in step S43, in an online multi-workflow scheduling process, each action obtains an immediate reward to evaluate quality of the action, and an average completion time of all DAG tasks is taken as a final long-term optimization goal.

10. The online multi-workflow scheduling method based on reinforcement learning according to claim 1, wherein for the environmental parameters and the network parameters in step S5:
the environmental parameters comprise an execution queue length, the bandwidth between the mobile device and the edge server, and a DAG task structure in the environment and in an upcoming environment; and
the network parameters comprise the network parameters in two policy networks and the graph convolution neural network.
